(19) United States
(12) Patent Application Publication
(10) Pub. No.: US 2021/0096719 A1
(43) Pub. Date: Apr. 1, 2021

(54) BEHAVIOR KEYS FOR SECONDARY DISPLAYS

(71) Applicant: Hewlett-Packard Development Company, L.P., Spring, TX (US)

(72) Inventor: Dong Ryul Cha, Spring, TX (US)

(73) Assignee: Hewlett-Packard Development Company, L.P., Spring, TX (US)

(21) Appl. No.: 16/978,722

(22) PCT Filed: Jun. 5, 2018
(86) PCT No.: PCT/US2018/036041

§ 371 Date: Sep. 7, 2020

(51) Int. Cl. G06F 3/0489; G06F 3/0481; G06F 3/02; G06F 1/16

(52) U.S. Cl. CPC G06F 3/0489; G06F 3/0481; G06F 1/1647; G06F 1/1616; G06F 3/0219

(57) ABSTRACT

In example implementations, an electronic device includes a primary display, a secondary display, and a keyboard. The secondary display is coupled to the primary display. The keyboard is coupled to the secondary display and includes a first behavior key and a second behavior key. The first behavior key is to change a first display operation of the secondary display while the primary display is active. The second behavior key is to change a second display operation of the secondary display while the primary display is active.

### BACKGROUND

Laptop computers are portable computing devices. The laptop computer provides the convenience of a full desktop computer, but packaged in a portable form factor that allows a user to travel with the laptop computer. The laptop computer may include a display and input/output devices combined into a single housing.

As the performance of electrical components improves, the processing capability of the laptop computer may also improve. Thus, laptop computers can execute gaming applications or other processor intensive applications that used to be run solely on desktop computers.

### BRIEF DESCRIPTION OF THE DRAWINGS

FIG. 1 is a block diagram of a top view of an example electronic device with a secondary display and a behavior keys for the secondary display;

FIG. 2 is a block diagram of an example keyboard of the electronic device with the behavior keys; and

FIG. 3 is a block diagram of an example non-transitory computer readable storage medium storing instructions executed by a processor to change a behavior of the secondary display while a primary display is active.

### DETAILED DESCRIPTION

Examples described herein provide behavior keys for secondary displays of an electronic device. As discussed above, as the performance of electronic devices, such as laptop computers, improves over time, the electronic devices may be used for processor intensive applications, such as video games. The electronic devices may be designed with a secondary display to provide more viewing areas to improve the user experience of some applications.

Examples herein provide physical keys that can be used to change the behavior of the secondary display. The physical keys may provide dedicated inputs. The behavior of the secondary display may be how the secondary display acts or performs while the primary display of the laptop computer is active. For example, the behavior keys may include buttons to migrate a selected app on the primary display into a full screen of the secondary display, go through dimming or brightening cycles for the secondary display, turn the secondary display on or off, disable or enable a touch feature of the secondary display, and so forth.

In addition, the behavior keys may be located to maximize user experience. For example, a right handed user may prefer to keep his left hand on directional keys (e.g., the AWS keys) of the keyboard. Thus, the behavior keys may be located over a track pad. In addition, the behavior keys may be differently shaped or textured to allow the user to identify the behavior keys without looking away from the primary display.

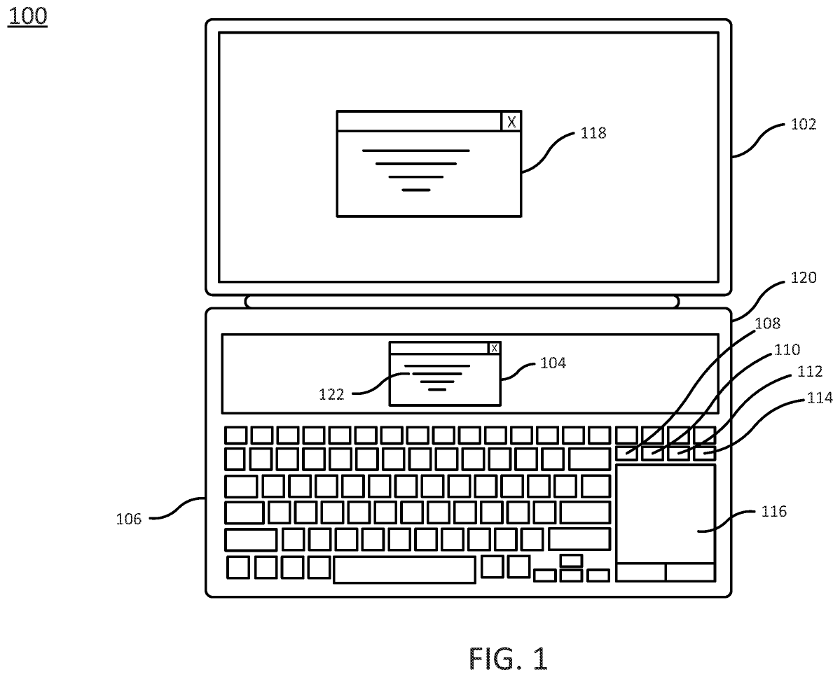

FIG. 1 illustrates a block diagram of an electronic device 100 having behavior keys 108, 110, 112, and 114 to change a display operation of a secondary display 104 of the present disclosure. In one example, the electronic device 100 may be a laptop computer, or any other portable computing device, that has a primary display 102 and the secondary display 104.

In one example, the primary display 102 may be the main display that is enclosed in a separate housing from a base, or keyboard, housing 120. In one example, the secondary display 104 may be coupled to the primary display 102 via the housing 120.

The housing 120 may include a keyboard 106. The secondary display 104 may be located above the keyboard 106. Said another way, the secondary display 104 may be located between the keyboard 106 and the primary display 102. The keyboard 106 may also include a trackpad 116. The trackpad 116 may be located towards a right side of the keyboard 106 for right handed users. In another example, the trackpad 116 may be located on the left side of the keyboard 106 for left handed users.

The secondary display 104 may be a touch screen display that may be used in a variety of different ways for different applications. For example, the secondary display 104 may be used as a heads-up display, a map, and the like, for gaming applications. The secondary display 104 may be used as a color palette for photo editing applications. The secondary display 104 may be used to play videos or view images while working with a productivity application in the primary display 102, and so forth.

The secondary display 104 may be a relatively small additional screen that helps the electronic device 100 be more productive or efficient. The secondary display 104 may be a light emitting diode (LED) display. The secondary display 104 may have a viewing area of several inches (e.g., approximately 2-5 inch display).

The behavior keys 108, 110, 112, and 114 may be located adjacent to the trackpad 116. In one example, the behavior keys 108, 110, 112, and 114 may be located above the trackpad 116, as illustrated in FIG. 1. In another example, the behavior keys 108, 110, 112, and 114 may be located along an outer edge or a bottom edge of the trackpad 116.

The behavior keys 108, 110, 112, and 114 may provide dedicated and separate physical buttons to change a behavior of the secondary display 104. In other words, a single key may be pressed to change a behavior of the secondary display 104, rather than using a combination of keys and/or keystrokes. Changing the behavior of the secondary display 104 may include changing a display operation of the secondary display 104. Changing the behavior of the secondary display 104 may involve more than a simple power button to turn on and off the secondary display 104.

Previous electronic devices 104 with a secondary display did not provide dedicated buttons to change the behavior of the secondary display. In some instances, key combinations would be used to change the behavior of the secondary display. However, in certain circumstances the user may not be able to, or want to, use keystroke combinations.

For example, the electronic device 100 may be used to play a video game. The user may have his or her left hand on the “WASZ” keys for directional control and his or her eyes on the primary display 102. The present disclosure may provide the behavior keys 108, 110, 112, and 114 such that the user may change the behavior of the secondary display 104 with a single hand and without having to look away from the primary display 102. [owls] In one example, the behavior keys 108, 110, 112, and 114 may be located on the right hand side above the track pad 116. Most users may be right handed. A right handed user may use his or her right hand to make key selections, while the user's left hand is continuously hovering over the directional keys on the left side of the keyboard 106. The location of the behavior keys 108, 110, 112, and 114 may allow a right handed user to use his or her right hand to select one of the behavior keys 108, 110, 112, and 114 without removing his or her left hand from the directional keys on the left side of the keyboard 106.

In one example, each one of the behavior keys 108, 110, 112, and 114 may be associated with a different display operation. The display operation may be executed on the secondary display 104 while the primary display 102 is active. In other words, the behavior keys 108, 110, 112, and 114 are not to turn on the secondary display 104 to be independently used apart from the primary display 102 or related to mechanical movement of the secondary display 102. Rather, the behavior keys 108, 110, 112, and 114 may affect what the secondary display 104 displays, or how the secondary display 104 operates.

For example, the first behavior key 108 may be associated with migrating a selected application 118 in the primary display 102 to the secondary display 104. For example, the selected application 118 may be an image, an application, a graphic, a video, and the like, that is currently selected and in the foreground of the primary display 102. The user may want to migrate the selected application 118 to the secondary display 104.

In one example, the user may select the behavior key 108 to move the selected application 118 to the secondary display 104. As illustrated in FIG. 1, an application 122 displayed in the secondary display 104 may be the selected application 118 from the primary display 102. The behavior key 108 may also maximize the size of the selected application 118 in the secondary display 104 automatically. In other words, when the behavior key 108 is selected, the selected application 118 may be automatically migrated to the secondary display 104 in a full screen mode.

In one example, the selected application 118 may disappear from the primary display 102. In another example, the selected application 118 may appear in both the primary display 102 and the secondary display 104 after migration.

The second behavior key 110 may cycle through a brightness level of the secondary display 104. For example, each time the behavior key 110 is selected, the brightness level of the secondary display 104 may change by a predetermined amount. The number of different levels that can be cycled via the behavior key 110 may also be predetermined. For example, the cycle of brightness levels may have four different levels and each level may increment the brightness of the secondary display 104 by 25%. For example, the levels may be a first level that is 25% of the maximum brightness, a second level that is 50% of the maximum brightness, a third level that is 75% of the maximum brightness, and a fourth level that is the maximum brightness. Each time the behavior key is selected, the brightness level may cycle through the different levels of brightness.

It should be noted that the above values and levels are provided as an example. Any number of levels and increments may be used. The increments may be even or may be uneven increments.

The third behavior key 112 may turn off the secondary display 104 or place the secondary display 104 in a “sleep mode.” For example, the user may be watching a movie on the primary display 102 and want to eliminate the glow of the secondary display 104 while watching the movie. Thus, the user may select the behavior key 112 to turn off the secondary display 104.

However, the behavior key 112 may “turn off” the secondary display 104 by reducing the brightness level to zero rather than actually powering down the secondary display 104. In current electronic devices with secondary displays, when the secondary display is powered off or placed in “sleep mode” the primary display may flicker. The flickering may be caused by the shared control and power of the primary display and the secondary display via a single graphics controller. Thus, the primary display may flicker when the secondary display is powered down.

In contrast, the electronic device 100 may “turn off” the secondary display 104 by minimizing the brightness level to 0. As a result, flickering of the primary display 102 may be prevented. Flickering of the primary display 102 may disrupt the user experience of a movie, a video, a video game, and the like, being consumed on the primary display 102. Minimizing the brightness level of the secondary display 104 to zero may be equivalent to “turning off” the secondary display 104 and reduce power consumption.

The fourth behavior key 114 may disable a touch feature of the secondary display 104. For example, the user may want to avoid accidentally selecting an option or soft key in the secondary display 104. The user may select the behavior key 114 to temporarily disable the touch feature of the secondary display 104. The user may select the behavior key 114 a second time to re-enable the touch feature of the secondary display 104.

It should be noted that although four different examples of dedicated behavior keys are described above, any number of dedicated behavior keys to change the behavior of the secondary display 104 may be deployed. Other behaviors of the secondary display 104 not described above may also be deployed.

In one example, the behavior keys 108, 110, 112, and 114 may have a different size, a different texture, and the like. Thus, the user may identify the behavior keys 108, 110, 112, and 114 without looking away from the primary display 102.

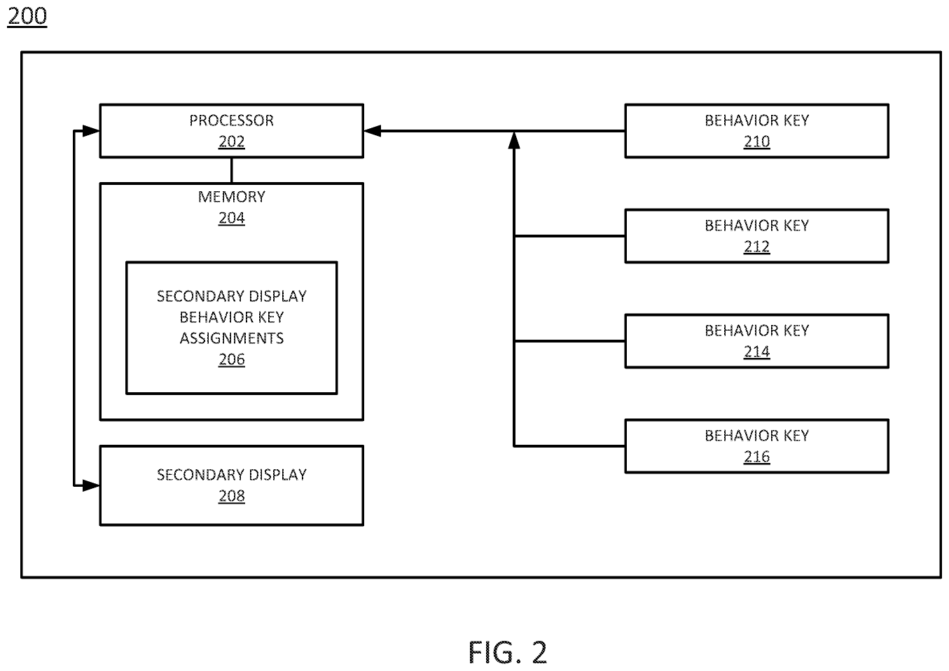

FIG. 2 illustrates a block diagram of an example keyboard 200 having behavior keys 210, 212, 214, and 216 of the present disclosure. In one example, the keyboard 200 may include a processor 202, a memory 204, a secondary display 208, and behavior keys 210, 212, 214, and 216. The processor 202 may be communicatively coupled to the memory 204, the secondary display 208, and the behavior keys 210, 212, 214, and 216. The keyboard 200 may also be coupled to a primary display that is not shown, similar to the primary display 102 illustrated in FIG. 1.

The memory 204 may be any type of non-transitory computer readable storage medium. For example, the memory 204 may be a hard disk drive, a random access memory (RAM), a read only memory (ROM), and the like. In one example, the memory 204 may store secondary display behavior key assignments 206. For example, the secondary display behavior key assignments 206 may identify which display operation of the secondary display 208 is associated with which behavior keys 210, 212, 214, and 216.

In one example, the secondary display behavior key assignments may store assignment of an operation to the behavior keys. For example, an operation of the secondary display 208 that is associated with the primary display 102 may be assigned to a first behavior key 210. Migrating a selected application in the primary display 102 to the secondary display may be an example of an operation of the secondary display 208 that is associated with the primary display 102.

An independent operation of the secondary display 208 may be assigned to a second behavior key 212. For example, the independent operation may be an operation of the secondary display 208 that is unrelated to the operation of the primary display 102. The independent operation may include operations that are related to a display appearance of the secondary display 208 or a function of the secondary display 208. Examples of operations related to the display appearance of the secondary display 208 may include cycling through a brightness level of the secondary display 208 or turning off the secondary display. Examples of operations related to the function of the secondary display 208 may include disabling a touch feature of the secondary display 208. In one example, the additional independent operations may be assigned to the third behavior key 214 and the fourth behavior key 216.

In one example, the secondary display behavior key assignments 206 may be predefined. For example, when the keyboard 200 is manufactured, the display operation associated with each behavior key 210, 212, 214, and 216 may be programmed and set. The user may not change the secondary display behavior key assignments 206.

In one example, the secondary display behavior key assignments 206 may be programmable. In other words, the behavior keys 210, 212, 214, and 216 may be programmable behavior keys. For example, the display operation of the secondary display 208 associated with each behavior key 210, 212, 214, and 216 may be user defined and/or changed.

For example, the behavior key 210 may be easier to reach with the right index finger of the user. The user may be comfortable selecting keys with his or her right index finger. The user may find that he or she frequently changes the brightness level of the secondary display 208. As a result, the user may assign the behavior key 210 to cycle the brightness level of the secondary display 208. The assignment may be stored in the secondary display behavior key assignments 206 in the memory 204.

At a later time, the user may find that he or she frequently migrates a selected application from the primary display to the secondary display 208. The user may change the assignment of the behavior key 210 from cycling the brightness level of the secondary display 208 to migrating selected applications from the primary display to the secondary display 208. The change in the assignment of the behavior key 210 may be stored in the secondary display behavior key assignments 206.

In one example, the processor 202 may receive an indication of a selection of one of the behavior keys 210, 212, 214, or 216. The processor 202 may execute a display operation based on an input received from the selected behavior key 210, 212, 214, 216, or any combination thereof, and the secondary display behavior key assignments 206 stored in the memory 204. For example, the assignments of the behavior keys 210, 212, 214, and 216 stored in the secondary behavior key assignments 206 may determine the display operation to be executed by the processor. The processor 202 may then execute the display operation, or sequence of display operations, associated with the selected behavior key, or combination of behavior keys 210, 212, 214, and/or 216 on the secondary display 208 while the primary display is still active.

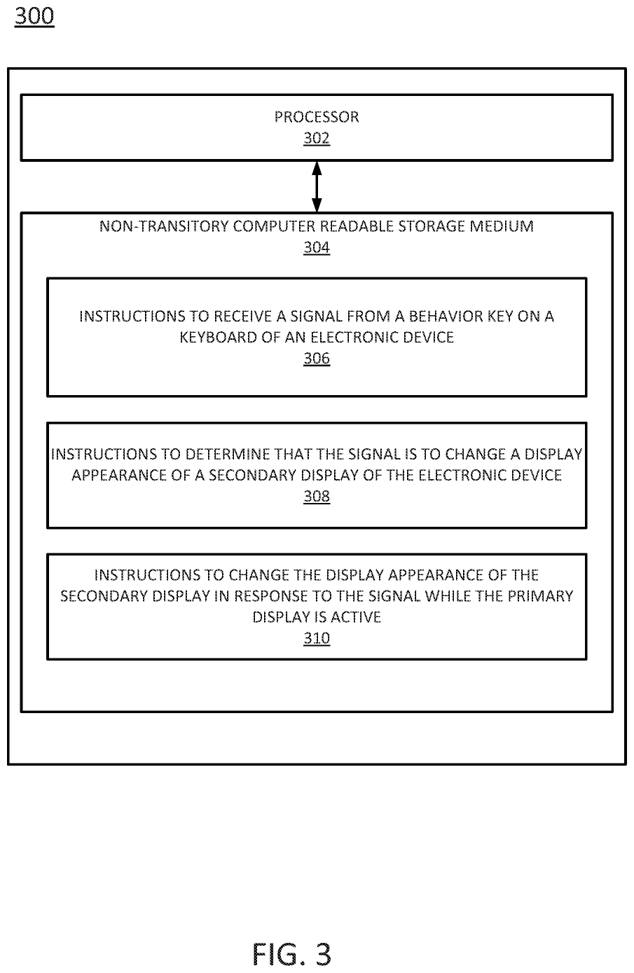

FIG. 3 illustrates an example of an apparatus 300. In one example, the apparatus 300 may be the electronic device 100. In one example, the apparatus 300 may include a processor 302 and a non-transitory computer readable storage medium 304. The non-transitory computer readable storage medium 304 may include instructions 306, 308, and 310, that, when executed by the processor 302, cause the processor 302 to perform various functions to change a display operation of a secondary display based on a selection of a behavior key.

In one example, the instructions 306 may include instructions to receive a signal from a behavior key on a keyboard of an electronic device. The signal may be an electrical signal generated by pressing one of the behavior keys on a keyboard.

In one example, a plurality of behavior keys may be included on the keyboard. Each one of the plurality of behavior keys may selected to change a different display appearance of the secondary display. For example, a first behavior key may be associated with migrating a selected application in the primary display to the secondary display. A second behavior key may be associated with cycling through a brightness level of the secondary display. A third behavior key may be associated with turning off the secondary display, or placing the secondary display in a sleep mode.

Some of the behavior keys may be selected to change functionality of the secondary display. For example, a fourth behavior key may be associated with disabling a touch feature of the secondary display.

It should be noted that the above assignment of different display operations to the different behavior keys is provided as an example. As noted above, the behavior keys can be programmed to be associated with any of the example display operations described herein.

The instructions 308 may include instructions to determine that the signal is to change a display appearance of a secondary display of the electronic device. In one example, the change to the display appearance of the secondary display associated with each one of the behavior keys may be stored in memory. For example, the assignments may be stored in a secondary display behavior key assignments table or database. The secondary display behavior key assignments table may correlate the different signals from the different behavior keys to respective behavior changes.

The instructions 310 may include instructions to change the display appearance of the secondary display in response to the signal while the primary display is active. For example, the identified behavior change may be implemented on the secondary display. The behavior change may be to migrate a selected application in a full display mode in the secondary display, change a brightness level of the secondary display, place the secondary display in a sleep mode, disable or enable a touch feature of the secondary display, and the like, as described above.

Thus, the present disclosure provides dedicated behavior keys for a secondary display on an electronic device. The dedicated behavior keys may provide a single key that can change a behavior or a display operation of the secondary display. In addition, the location of the behavior keys for the secondary display may allow users to easily identify and select the behavior keys.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An electronic device, comprising:
a primary display;
a secondary display coupled to the primary display; and
a keyboard coupled to the secondary display, wherein the keyboard comprises a first behavior key and a second behavior key, wherein the first behavior key is to change a first display operation of the secondary display while the primary display is active, and wherein the second behavior key is to change a second display operation of the secondary display while the primary display is active.

2. The electronic device of claim 1, wherein the first display operation associated with first behavior key comprises migrating a selected application in the primary display to the secondary display.

3. The electronic device of claim 2, wherein the selected application is migrated into a full display of the secondary display automatically.

4. The electronic device of claim 1, wherein the second display operation associated with second behavior key comprises cycling through a brightness level of the secondary display.

5. The electronic device of claim 1, wherein the keyboard comprises a third behavior key to turn off the secondary display.

6. The electronic device of claim 5, wherein the secondary display is turned off by setting a brightness level of the secondary display to zero while keeping the secondary display powered on.

7. The electronic device of claim 1, keyboard comprises a fourth behavior key to disable a touch feature of the secondary display.

8. The electronic device of claim 1, wherein the keyboard comprises a track pad located on a right hand side of the keyboard, wherein the first behavior key and the second behavior key are located adjacent to the track pad.

9. An electronic device, comprising:
a secondary display;
a first behavior key;
a second behavior key;
a memory to store secondary display behavior key assignments, wherein the secondary display behavior key assignments comprise an assignment of an operation of the secondary display that is associated with a primary display to the first behavior key and an assignment of an independent operation of the secondary display to the second behavior key;
a processor communicatively coupled to the secondary display, the first behavior key, the second behavior key, and the memory, wherein the processor is to execute a display operation based on an input from the first behavior key, the second behavior key, or a combination thereof, while a primary display is active.

10. The electronic device of claim 9, wherein the independent operation of the secondary display comprises a display appearance of the secondary display.

11. The electronic device of claim 9, wherein the independent operation of the secondary display comprises a display function of the secondary display.

12. The electronic device of claim 9, further comprising:
a keyboard housing comprising a keyboard and a trackpad, wherein the secondary display is located on the keyboard housing and the first behavior key and the second behavior key are located above the trackpad.

13. A non-transitory machine-readable storage medium encoded with instructions executable by a processor of an electronic device, the machine-readable storage medium comprising:
instructions to receive a signal from a behavior key on a keyboard of an electronic device;
instructions to determine that the signal is to change a display appearance of a secondary display of the electronic device; and
instructions to change the display appearance of the secondary display in response to the signal while the primary display is active.

14. The non-transitory machine-readable storage medium of claim 13, wherein the display appearance comprises migrating a selected application in the primary display to the secondary display, cycling through a brightness level of the secondary display, or turning off the secondary display.

15. The non-transitory machine-readable storage medium of claim 14, wherein the change to the display appearance associated with the behavior key is programmable.
